(19) United States
(12) Patent Application Publication
(10) Pub. No.: US 2005/0193208 A1
(43) Pub. Date: Sep. 1, 2005

(54) User authentication

(76) Inventors: Edmond Eldrick Charrette III, Lincoln, MA (US); Richard Rosenbaum, Lincoln, MA (US)

Correspondence Address: FISH & RICHARDSON PC, 225 FRANKLIN ST, BOSTON, MA, 02110, US

(21) Appl. No.: 10/787,685

(22) Filed: Feb. 26, 2004

(51) Int. Cl. H04L 9/00

(52) U.S. Cl. 713/182

(57) ABSTRACT

There are methods and apparatus, including computer program products, for user authentication. For example, there is a method that includes generating a dynamic mapping between assigned authentication symbols and temporary authentication symbols, presenting the dynamic on an electronic device, and receiving a selection signal that identifies one or more of the temporary authentication symbols.

### BACKGROUND

This description relates to user authentication.

Systems for authenticating online users of computer-based services can be compromised by use of techniques such as “keyboard-sniffing” or “spyware.” These techniques capture the entry keystrokes of users logging onto authenticated online services (e.g., using hardware attached to an input device or software loaded onto a user's computer). Subsequently, the captured keystrokes can be used by malicious attackers to impersonate the original user and potentially access information and perform transactions using the identity of that user, without the knowledge or permission of that user. Some systems reduce the success of such techniques using a “one-time” password that is provided by a hardware token or “smart card.” The “one-time” password, if captured, is not useful to a potential attacker.

### SUMMARY

In one aspect, there is a method that includes generating a dynamic one-to-one mapping between assigned authentication symbols and temporary authentication symbols, presenting the dynamic one-to-one mapping on an electronic device, and receiving a selection signal that identifies one or more of the temporary authentication symbols.

Other examples may include one or more of the following features.

The assigned authentication symbols correspond to alphanumeric characters.

The temporary authentication symbols correspond to keystrokes on a keyboard.

The selection signal includes a signal from the keyboard.

The dynamic one-to-one mapping is presented in an image. The image may include obscured symbols. The obscured symbols may include obscured text and/or a CAPTCHA.

The method includes providing authentication to a user, based on the identified temporary authentication symbols, the dynamic one-to-one mapping, and a user credential.

The dynamic one-to-one mapping is generated according to a pseudorandom algorithm.

The method includes changing the dynamic one-to-one mapping after a log on attempt.

The dynamic one-to-one mapping is sent to the electronic device over a communication channel.

In another aspect, there is a method that includes generating a dynamic mapping between symbols and respective subsets of screen coordinates of an electronic device, and receiving a selection signal that identifies one or more of the subsets of screen coordinates. The dynamic mapping changes at least after each log on attempt.

Other examples may include one or more of the following features.

The symbols correspond to alphanumeric characters.

The subsets of screen coordinates correspond to on-screen buttons.

The on-screen buttons include a button labeled with a plurality of symbols.

The on-screen buttons include a plurality of buttons labeled with the same symbol.

The on-screen buttons include more than ten buttons.

The selection signal is received from an input device that bypasses a keyboard. The input device may control an on-screen pointer. The input device may include a mouse.

The method includes providing authentication to a user, based on the identified subsets of screen coordinates, the dynamic mapping, and a user credential.

The dynamic mapping is generated according to a pseudorandom algorithm.

The dynamic mapping is sent to the electronic device over a communication channel.

In another aspect, there is a method that includes generating a dynamic spatial mapping between assigned authentication locations and temporary authentication symbols, presenting the dynamic spatial mapping in an image on an electronic device, and receiving a selection signal that identifies one or more of the temporary authentication symbols.

Other examples may include one or more of the following features.

The dynamic spatial mapping locates the temporary authentication symbols at respective locations within the image corresponding to the assigned authentication locations.

The image represents an identification card.

The assigned authentication locations correspond to locations of holes in the identification card.

The temporary authentication symbols correspond to keystrokes on a keyboard.

The selection signal includes a signal from the keyboard.

The method includes providing authentication to a user, based on the identified temporary authentication symbols, the dynamic spatial mapping, and a user credential.

The dynamic spatial mapping is generated according to a pseudorandom algorithm.

The method includes changing the dynamic spatial mapping after a log on attempt.

The dynamic spatial mapping is sent to the electronic device over a communication channel.

In another aspect, there is a system that includes a server module configured to generate a dynamic one-to-one mapping between assigned authentication symbols and temporary authentication symbols, and a client module. The client module is configured to present the dynamic one-to-one mapping on an electronic device, and receive a selection signal that identifies one or more of the temporary authentication symbols.

In another aspect, there is a system that includes a server module configured to generate a dynamic mapping between symbols and respective subsets of screen coordinates of an electronic device, and a client module. The client module is configured to receive a selection signal that identifies one or more of the subsets of screen coordinates.

In another aspect, there is a system that includes a server module configured to generate a dynamic spatial mapping between assigned authentication locations and temporary authentication symbols, and a client module. The client module is configured to present the dynamic spatial mapping on an electronic device, and receive a selection signal that identifies one or more of the temporary authentication symbols.

In another aspect, there is an article of manufacture having computer-readable program portions embodied therein. The article includes instructions for causing a processor to perform any combination of the methods described above.

One or more of the following advantages may be provided by one or more of the aspects described above. An authentication system provides enhanced authentication of users of online services. The system increases the security of such services by reducing vulnerability to certain attacks such as “keyboard entry capture” attacks. Presenting a dynamic mapping on a screen can be more convenient than generating a dynamic mapping by a token. Obscuring symbols makes it more difficult to automatically recognize the obscured symbols in a captured screen image. Receiving a selection signal that bypasses a keyboard also reduces vulnerability to keyboard entry capture attacks.

Other features and advantages of the invention will become apparent from the following description, and from the claims.

### DESCRIPTION OF DRAWINGS

FIG. 1A is a diagram of an authentication system.

FIG. 1B is a flowchart of an authentication process.

FIGS. 2, 3A, 4, and 5 are authentication screen images.

FIG. 3B is a user identification card.

FIG. 3C shows the user identification card of FIG. 3B identifying temporary authentication symbols.

### DESCRIPTION

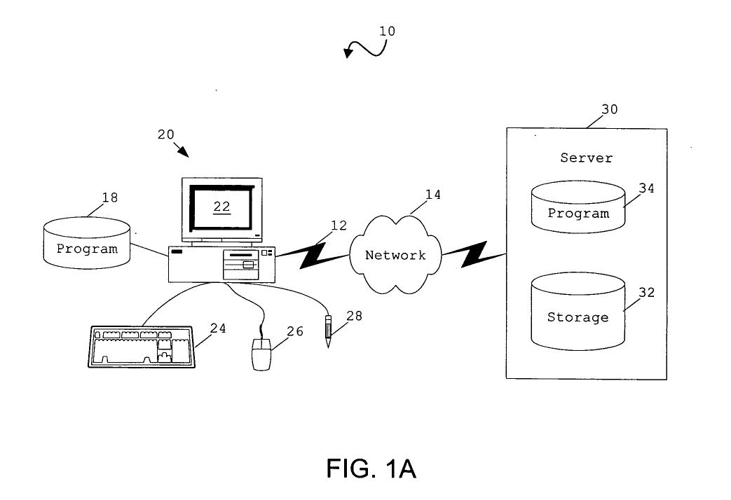

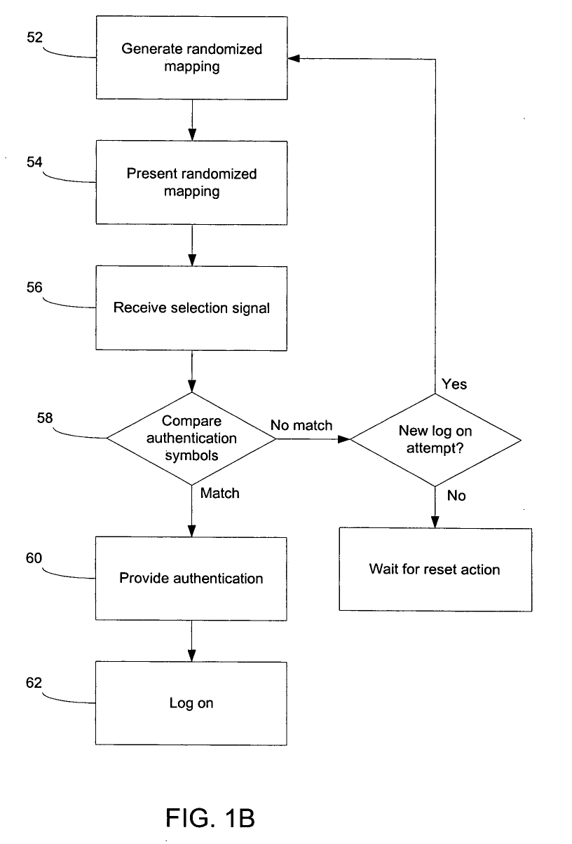

Referring to FIG. 1A, a diagram of a dynamic mapping authentication system 10 includes a computer terminal 20 having access to a server 30 over a communication channel 12 (e.g., a connection over a network 14, or a point-to-point connection to the server 30). The server 30 includes a storage module 32 that stores one or more user credentials (e.g., a credential including a username and a password) associated with users that have permission to access online services provided by the server 30 or another system accessible via the server 30. Before granting the user access to the online services, the system 10 provides authentication of the user based on one of the stored user credentials.

The system 10 provides authentication of the user through interactions between a client program 18 loaded on the computer terminal 20 and a server program 34 loaded on the server 30. A user who is to be authenticated by the system 10 is assigned a series of authentication symbols (e.g., a series of alphanumeric characters) that correspond to a representation of those authentication symbols (e.g., an ASCII string) stored as part of a user credential in the storage module 32. Referring to FIG. 1B, the server program 34 generates (52) a dynamic mapping between a set of possible assigned authentication symbols (e.g., the digits 0, 1, 2, 3) and a set of temporary authentication symbols (e.g., the letters A, B, C, D). The server program 34 sends a representation of the dynamic mapping (e.g., 0=D, 1=F, 2=C, 3=B) to the terminal 20. The client program 18 presents (54) the dynamic mapping in an image on a display screen 22 of the terminal 20.

Each time a user attempts to log on, the client program 18 presents the user an authentication dialog that includes the image representing the dynamic mapping and boxes for entering portions of the user credential such as a log on name or identification (ID). The authentication dialog also includes one or more boxes to answer a “challenge” that is based on the dynamic mapping. This challenge can be, for example, a password or personal identification number (PIN) based on the dynamic mapping. To answer the challenge, the user identifies a series of temporary authentication symbols (e.g., BFC) that correspond to the series of authentication symbols assigned to the user (e.g., 312, using the example mapping described above) according to the visually presented dynamic mapping.

The user enters the series of temporary authentication symbols using an input device such as a keyboard 24, a mouse 26, a stylus 28, a touch screen (not shown) of the computer terminal 20, or other similar input device. The user can enter the series of temporary authentication symbols, for example, by typing in a text box or by selecting portions of the image representing the dynamic mapping. The input device provides a selection signal that identifies the entered series of temporary authentication symbols to the client program 18. The client program 18 receives (56) the selection signal and sends a representation of the user-selected temporary authentication symbols to the server program 34. The server program 34 converts the received temporary authentication symbols into corresponding possible assigned authentication symbols (according to the dynamic mapping) and compares (58) the possible assigned authentication symbols to the actual assigned authentication symbols (e.g., as determined by a stored user credential for the user). If the possible assigned authentication symbols match the actual authentication symbols, then the server program 34 provides authentication (60) allowing the user to successfully log on (62). If the possible assigned authentication symbols do not match the actual authentication symbols, then the server program 34 does not allow the user to log on. After an unsuccessful log on attempt, the server program 34 provides a new log on attempt with a new dynamic mapping. Alternatively, the server program 34 may prevent further log on attempts (e.g., after a predetermined number of unsuccessful log on attempts) until after a particular reset action is performed.

The server program 34 generates the dynamic mapping, in the examples described herein, by using a pseudorandom number to select a temporary authentication symbol that is mapped to a given assigned authentication symbol using any of a variety of techniques for generating pseudorandom numbers. Since a new dynamic mapping is used for a new log on attempt, selection signals (e.g., keystrokes or pointer coordinates) captured by a potential attacker are not useful to the attacker for attempting to log on or otherwise compromise the system 10 unless the attacker also captures the associated dynamic mapping.

To make it more difficult for a potential attacker to capture the dynamic mapping, the image representing the dynamic mapping on the screen 22 can include obscured symbols. Even if an attacker managed to capture screen pixels at the correct screen location (or the entire screen) and at the correct display time to capture the image, the obscured symbols would make it difficult for the attacker to interpret the dynamic mapping using a computer program. For example, the image can be processed using any of a variety of techniques for preventing computers from recognizing symbols using a “completely automated public Turing test to tell computers and humans apart” known as a “CAPTCHA.”

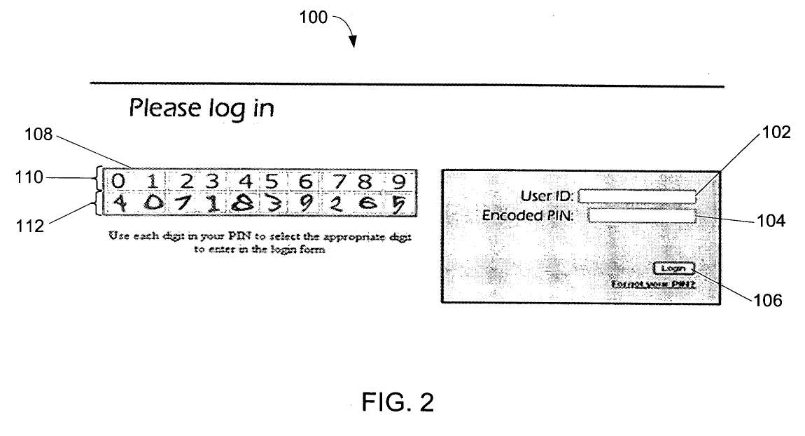

In a first example shown in FIG. 2, an authentication dialog 100 includes a user identification text box 102 for a user to enter a “User ID” portion of a user credential. The user credential also includes a secret PIN representing the user's assigned authentication symbols. The authentication dialog 100 includes a challenge text box 104 for the user to enter an “Encoded PIN” representing temporary authentication symbols determined using a visually presented dynamic mapping 108.

The user determines the Encoded PIN by replacing the digits of the secret PIN, found in the top row 110 of sorted digits 0-9 of the dynamic mapping 108, with digits found in the bottom row 112 of scrambled digits of the dynamic mapping 108. In this example, the dynamic mapping 108 is a one-to-one mapping between potential assigned authentication symbols and potential temporary authentication symbols. After the user enters the keystrokes corresponding to the digits of the Encoded PIN, the user presses a “Login” button 106 to indicate that the client program 18 can send a representation of the Encoded PIN to the server program 34 to authenticate the user. The scrambled digits in the bottom row 112 change each time the user attempts to log on to the system 10. In this example, the temporary authentication symbols are obscured, as shown in FIG. 2, by the distorted digits in the bottom row 112 of the dynamic mapping 108. For the authentication using the illustrated mapping 108, a PIN of 0123 (i.e., assigned authentication symbols) is entered by the user as 4071 (i.e., temporary authentication symbols). The next time the same user logged into the system, the mapping would be different, so the temporary authentication symbols entered by the user to represent her assigned authentication symbols of 0123 would be different.

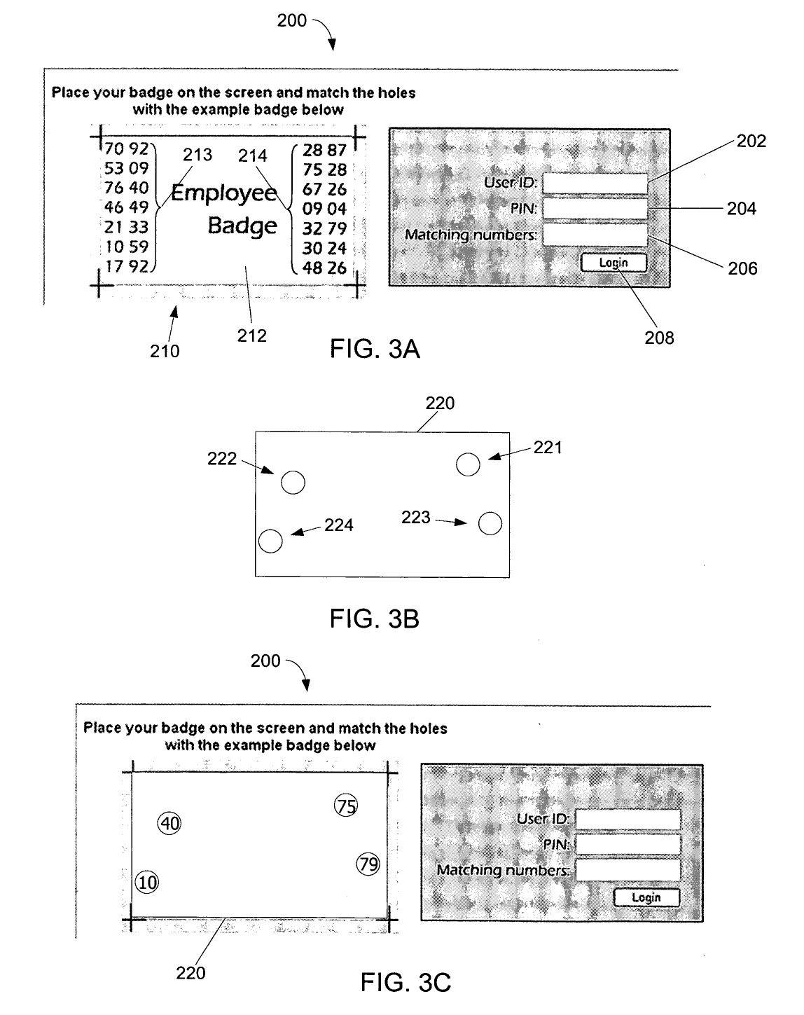

In a second example shown in FIG. 3A, an authentication dialog 200 includes a user identification text box 202 for a user to enter a “User ID” portion of a user credential. The user credential also includes a secret PIN and a digital representation of spatial information that corresponds to an arrangement of holes 221-224 in a user-possessed identification card 220 (as shown in FIG. 3B). The locations of the holes 221-224 correspond to a user's “assigned authentication locations” as encoded in the spatial information. The authentication dialog 200 includes a text box 204 for the user to enter the secret PIN and a challenge text box 206 for the user to enter “matching numbers” representing temporary authentication symbols determined using a visually presented dynamic spatial mapping 210. The dynamic spatial mapping 210 includes a left set 213 of seven rows and two columns of two digit numbers and a right set 214 of seven rows and two columns of two digit numbers. The sets 213-214 of numbers are presented over an image 212 representing an identification card 220 (without the holes).

The user determines the matching numbers by placing the user's identification card 220 over the image 212 so that four two digit numbers show through the holes 221-224 as shown in FIG. 3C. The user concatenates the four numbers in a predetermined order. For example, going from left to right across successive columns of the sets 213-214 of numbers yields the matching numbers “75407910” through holes 221, 222, 223, 224, respectively. After the user enters the keystrokes corresponding to the digits of the matching numbers, the user presses a “Login” button 208 to indicate that the client program 18 can send a representation of the matching numbers to the server program 34 to authenticate the user. The digits in the sets 213-214 of numbers change each time the user attempts to log on to the system 10.

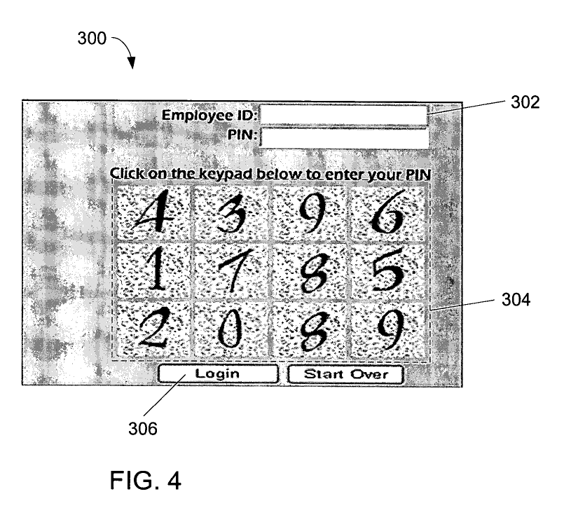

In a third example shown in FIG. 4, an authentication dialog 300 includes a user identification text box 302 for a user to enter an “Employee ID” portion of a user credential. The user credential also includes a secret PIN representing the user's assigned authentication symbols. The authentication dialog 300 includes a dynamic mapping in the form of a grid 304 of three rows and four columns of boxes (or “on-screen buttons”) containing obscured digits. The digits 0-9 are each represented in at least one of the twelve boxes of the grid 304. In this example, the digits “8” and “9” are each contained in two of the boxes. So, in this example, the dynamic mapping is a one-to-many mapping between potential assigned authentication symbols and potential temporary authentication symbols. In other implementations, the dynamic mapping is a one-to-one mapping.

In this example, the user enters the temporary authentication symbols by selecting a sequence of screen locations, guided by the randomly arranged digits in the grid 304, in an order that corresponds to the user's secret PIN. Each temporary authentication symbol corresponds to a subset of screen locations corresponding to one or more of the boxes. The user implicitly identifies a temporary authentication symbol by selecting any of the screen locations in a corresponding box using a pointing device (e.g., “clicking” a button of the mouse 26 while an on-screen pointer is over the box). The selection signal provided by the pointing device bypasses a keyboard, reducing vulnerability to keyboard entry capture attacks.

After the user selects the sequence of screen locations, the user presses a “Login” button 306 to indicate that the client program 18 can send a representation of the selected screen locations to the server program 34 to authenticate the user. The arrangement of the digits in the grid 304 changes each time the user attempts to log on to the system 10. In this example, the temporary authentication symbols are obscured, as shown in FIG. 4, by the distorted digit and the speckled pattern in the background of each of the boxes of the grid 304.

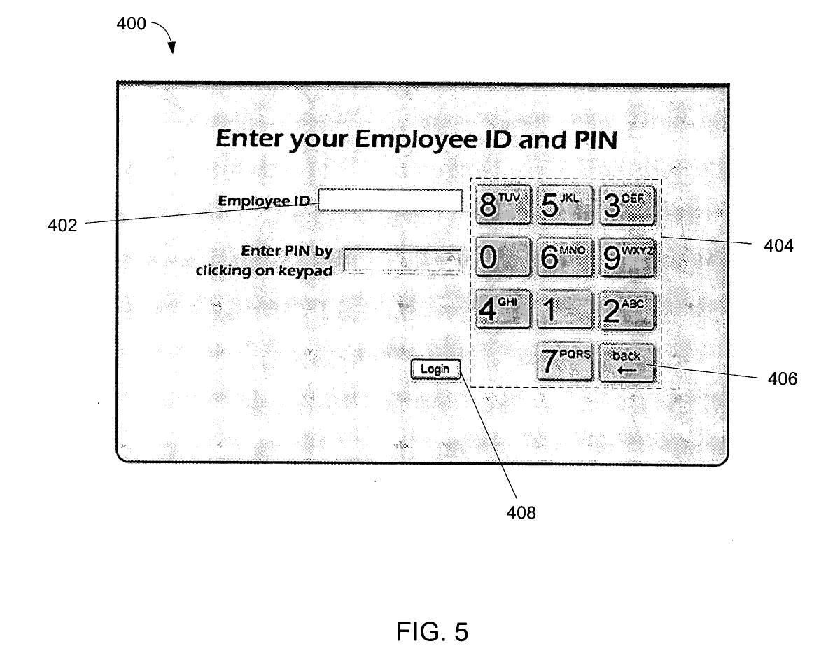

In a fourth example shown in FIG. 5, an authentication dialog 400 includes a user identification text box 402 for a user to enter a “Employee ID” portion of a user credential. The user credential also includes a secret PIN representing the user's assigned authentication symbols. The authentication dialog 400 includes a dynamic mapping in the form of an on-screen keypad 404. The keypad 404 includes keys or “on-screen buttons” labeled with the digits 0-9 and the letters A-Z. In this example, some of the keys include multiple symbols. So, in this example, the dynamic mapping is a many-to-one mapping between potential assigned authentication symbols and potential temporary authentication symbols. The keypad 404 has a randomized layout of keys with some keys labeled with multiple letters and one number according to a standard keypad (e.g., a telephone keypad). Alternatively, the keypad 404 can include keys labeled with multiple randomized symbols that do not correspond to a standard keypad.

In this example, the user enters the temporary authentication symbols by selecting a sequence of screen locations, guided by the randomly arranged keys in the keypad 404, in an order that corresponds to the user's secret PIN. Each temporary authentication symbol corresponds to a subset of screen locations corresponding to one of the keys. The user implicitly identifies a temporary authentication symbol by selecting any of the screen locations in the corresponding key using a pointing device (e.g., “clicking” a button of the mouse 26 while an on-screen pointer is over the key). The keypad 404 also includes a “back” key 406 for correcting (i.e., deleting) a selected temporary authentication symbol (e.g., to correct an entry error by a user).

After the user selects the sequence of screen locations, the user presses a “Login” button 408 to indicate that the client program 18 can send a representation of the selected screen locations to the server program 34 to authenticate the user. The arrangement of the digits and letters in the keypad 404 changes each time the user attempts to log on to the system 10.

Other embodiments are within the scope of the following claims. For example, the client program 18 can generate the dynamic mapping and convert the user-selected temporary authentication symbols into the corresponding assigned authentication symbols to be sent to the server program 34. All of the processes described herein can be performed by a single device. The computer terminal 20 can have any of a variety of form factors, for example, a desktop computer, a laptop computer, a handheld computer, or other portable electronic device (e.g., a personal digital assistant (PDA), or cell phone). The authentication system 10 can provide authentication based on interactions between any number of local or remote programs, or based on a single program. Although numbers are used in the examples above for simple illustration, letters and symbols can also be randomly mapped as assigned authentication symbols and/or temporary authentication symbols. Instead of a visually presented dynamic mapping, a dynamic mapping can be presented in another manner on an electronic device, for example, as a mapping between audio symbols over a telephone, cell phone, or computer speaker.

1. A method comprising:
generating a dynamic one-to-one mapping between assigned authentication symbols and temporary authentication symbols;
presenting the dynamic one-to-one mapping on an electronic device; and
receiving a selection signal that identifies one or more of the temporary authentication symbols.

2. The method of claim 1 wherein the assigned authentication symbols correspond to alphanumeric characters.

3. The method of claim 1 wherein the temporary authentication symbols correspond to keystrokes on a keyboard.

4. The method of claim 3 wherein the selection signal comprises a signal from the keyboard.

5. The method of claim 1 wherein the dynamic one-to-one mapping is presented in an image.

6. The method of claim 5 wherein the image includes obscured symbols.

7. The method of claim 6 wherein the obscured symbols comprise obscured text.

8. The method of claim 6 wherein the obscured symbols comprise a CAPTCHA.

9. The method of claim 1 further comprising:
providing authentication to a user, based on the identified temporary authentication symbols, the dynamic one-to-one mapping, and a user credential.

10. The method of claim 1 wherein the dynamic one-to-one mapping is generated according to a pseudorandom algorithm.

11. The method of claim 1 further comprising changing the dynamic one-to-one mapping after a log on attempt.

12. The method of claim 1 wherein the dynamic one-to-one mapping is sent to the electronic device over a communication channel.

13. A system comprising:
a server module configured to generate a dynamic one-to-one mapping between assigned authentication symbols and temporary authentication symbols; and
a client module configured to:
present the dynamic one-to-one mapping on an electronic device; and
receive a selection signal that identifies one or more of the temporary authentication symbols.

14. The system of claim 13 wherein the server module is further configured to:
provide authentication to a user, based on the identified temporary authentication symbols, the dynamic one-to-one mapping, and a user credential.

15. The system of claim 13 wherein the dynamic one-to-one mapping is generated according to a pseudorandom algorithm.

16. An article of manufacture having computer-readable program portions embodied therein, the article comprising instruction for causing a processor to:
generate a dynamic one-to-one mapping between assigned authentication symbols and temporary authentication symbols;
present the dynamic one-to-one mapping on an electronic device; and
receive a selection signal that identifies one or more of the temporary authentication symbols.

17. The article of manufacture of claim 16 further comprising instruction for causing the processor to:
provide authentication to a user, based on the identified temporary authentication symbols, the dynamic one-to-one mapping, and a user credential.

18. The article of manufacture of claim 16 wherein the dynamic one-to-one mapping is generated according to a pseudorandom algorithm.

19. A method comprising:
generating a dynamic mapping between symbols and respective subsets of screen coordinates of an electronic device; and
receiving a selection signal that identifies one or more of the subsets of screen coordinates;
wherein the dynamic mapping changes at least after each log on attempt.

20. The method of claim 19 wherein the symbols correspond to alphanumeric characters.

21. The method of claim 19 wherein the subsets of screen coordinates correspond to on-screen buttons.

22. The method of claim 21 wherein the on-screen buttons include a button labeled with a plurality of symbols.

23. The method of claim 21 wherein the on-screen buttons include a plurality of buttons labeled with the same symbol.

24. The method of claim 21 wherein the on-screen buttons comprise more than ten buttons.

25. The method of claim 19 wherein the selection signal is received from an input device that bypasses a keyboard.

26. The method of claim 25 wherein the input device controls an on-screen pointer.

27. The method of claim 25 wherein the input device comprises a mouse.

28. The method of claim 19 further comprising:
providing authentication to a user, based on the identified subsets of screen coordinates, the dynamic mapping, and a user credential.

29. The method of claim 19 wherein the dynamic mapping is generated according to a pseudorandom algorithm.

30. The method of claim 19 wherein the dynamic mapping is sent to the electronic device over a communication channel.

31. A system comprising:
a server module configured to generate a dynamic mapping between symbols and respective subsets of screen coordinates of an electronic device; and
a client module configured to:
receive a selection signal that identifies one or more of the subsets of screen coordinates;
wherein the dynamic mapping changes at least after each log on attempt.

32. The system of claim 31 wherein the server module is further configured to:
provide authentication to a user, based on the identified subsets of screen coordinates, the dynamic mapping, and a user credential.

33. The system of claim 31 wherein the dynamic mapping is generated according to a pseudorandom algorithm.

34. An article of manufacture having computer-readable program portions embodied therein, the article comprising instruction for causing a processor to:
generate a dynamic mapping between symbols and respective subsets of screen coordinates of an electronic device; and
receive a selection signal that identifies one or more of the subsets of screen coordinates;
wherein the dynamic mapping changes at least after each log on attempt.

35. The article of manufacture of claim 34 further comprising instruction for causing the processor to:
provide authentication to a user, based on the identified subsets of screen coordinates, the dynamic mapping, and a user credential.

36. The article of manufacture of claim 34 wherein the dynamic mapping is generated according to a pseudorandom algorithm.

37. A method comprising:
generating a dynamic spatial mapping between assigned authentication locations and temporary authentication symbols;
presenting the dynamic spatial mapping in an image on an electronic device; and
receiving a selection signal that identifies one or more of the temporary authentication symbols.

38. The method of claim 37 wherein the dynamic spatial mapping locates the temporary authentication symbols at respective locations within the image corresponding to the assigned authentication locations.

39. The method of claim 37 wherein the image represents an identification card.

40. The method of claim 39 wherein the assigned authentication locations correspond to locations of holes in the identification card.

41. The method of claim 37 wherein the temporary authentication symbols correspond to keystrokes on a keyboard.

42. The method of claim 41 wherein the selection signal comprises a signal from the keyboard.

43. The method of claim 37 further comprising:
providing authentication to a user, based on the identified temporary authentication symbols, the dynamic spatial mapping, and a user credential.

44. The method of claim 37 wherein the dynamic spatial mapping is generated according to a pseudorandom algorithm.

45. The method of claim 37 further comprising changing the dynamic spatial mapping after a log on attempt.

46. The method of claim 37 wherein the dynamic spatial mapping is sent to the electronic device over a communication channel.

47. A system comprising:
a server module configured to generate a dynamic spatial mapping between assigned authentication locations and temporary authentication symbols; and
a client module configured to:
present the dynamic spatial mapping on an electronic device; and
receive a selection signal that identifies one or more of the temporary authentication symbols.

48. The system of claim 47 wherein the server module is further configured to:
provide authentication to a user, based on the identified temporary authentication symbols, the dynamic spatial mapping, and a user credential.

49. The system of claim 47 wherein the dynamic spatial mapping is generated according to a pseudorandom algorithm.

50. An article of manufacture having computer-readable program portions embodied therein, the article comprising instruction for causing a processor to:
generate a dynamic spatial mapping between assigned authentication locations and temporary authentication symbols;
present the dynamic spatial mapping on an electronic device; and
receive a selection signal that identifies one or more of the temporary authentication symbols.

51. The article of manufacture of claim 50 further comprising instruction for causing the processor to:
provide authentication to a user, based on the identified temporary authentication symbols, the dynamic spatial mapping, and a user credential.

52. The article of manufacture of claim 50 wherein the dynamic spatial mapping is generated according to a pseudorandom algorithm.
